(19) United States
(12) Patent Application Publication
(10) Pub. No.: US 2005/0081231 A1
(43) Pub. Date: Apr. 14, 2005

(54) Disk cartridge

(75) Inventors: Yasuyuki Abe, Miyagi (JP); Shuichi Kikuchi, Miyagi (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(73) Assignee: Sony Corporation

(21) Appl. No.: 10/959,722

(22) Filed: Oct. 6, 2004

(30) Foreign Application Priority Data
Oct. 8, 2003 (JP) P2003-350092

(51) Int. Cl. G11B 23/03

(52) U.S. Cl. 720/728

(57) ABSTRACT

There are provided a cartridge main body, in which a disk insertion/ejection port for housing an optical disk and for inserting and ejecting the optical disk to be housed, is formed on one of side surfaces at an insertion end for an disk drive apparatus, and a disk holding body which holds the optical disk to be housed in the cartridge main body and is movable in an insertion direction into the disk drive apparatus. If the disk holding body moves to the side of the disk insertion/ejection port in the cartridge main body, the disk holding body makes at least a part of the holding optical disk expose to outside of the disk insertion/ejection port.

### CROSS REFERENCES TO RELATED APPLICATIONS

The present invention claims priority to its priority document No. 2003-350092 filed in the Japanese Patent Office on Oct. 8, 2003, the entire contents of which being incorporated by reference herein.

### BACKGROUND OF THE INVENTION

1. Field of the Invention

The present invention relates to a disk cartridge holding a disk-like recording medium, in which an information signal such as a picture signal, a sound signal and the like can be recorded, by a disk holding body in a cartridge main body.

2. Description of the Related Art

Of optical disks spread among people as recording media, there is a bare disk such as a compact disc (CD) and a digital versatile disk (DVD), which is handled as an individual optical disk. A user takes out a single optical disk from a housing case, and loads the optical disk into a disk drive apparatus, thereby the recording and the reproducing of an information signal are performed in such a type of optical disk.

Moreover, in an optical disk adapted to have higher storage densities than the compact disc and the digital versatile disk so as to record a high image quality picture signal or a video signal, and further record a high fidelity sound signal for longer time, a track pitch or the like is remarkably narrow, and the spot diameter of light beam to be radiated is also extremely small, and furthermore a distance between the disk surface and an objective lens of an optical pickup is extremely small. Accordingly, if a minute scratch is formed on the surface of such an optical disk, or if dust or the like is attached, it becomes difficult to record an information signal accurately, or to read out a recorded information signal accurately. Accordingly, the optical disk with a higher storage density is used in a protected state, i.e., housed in a disk cartridge.

On the other hand, an electrical apparatus such as a digital video camera equipped with a drive device has been downsized for improving portability thereof. Accordingly, a recording medium to be used in the drive device also required to be downsized.

A disk drive apparatus using a disk cartridge housing an optical disk rotatably therein as a recording medium needs a transport mechanism or the like for drawing the disk cartridge into the disk drive apparatus, making it difficult to achieve downsizing of the disk drive apparatus. Moreover, even a disk drive apparatus using a single optical disk as the recording medium would need a transport mechanism of the disk holding body or the like if the disk drive apparatus transports the optical disk into the disk drive apparatus while holding the optical disk on a disk holding body such as a disk tray, and consequently downsizing of the disk drive apparatus becomes difficult.

That is to say, the optical disk with a higher storage density is needed to be used in a housed condition in a disk cartridge for preventing the optical disk from catching dust or the like thereto. On the other hand, in case of using a disk cartridge housing an optical disk rotatably as a recording medium, it is difficult to achieve downsizing of the disk drive apparatus. A disk drive apparatus configured to transport a single optical disk into the apparatus is easiest to downsize.

There are the following Patent Documents 1-5 as the documents pertaining to the present invention.

The disk cartridges disclosed in Patent Document 1, Patent Document 2 and Patent Document 3 are ones in which a disk holding body for holding a disk is housed in the cartridge main body, and the disk cartridges severally draw out the disk holding body holding the disk to a read/write position to perform the recording and the reproducing of an information signal. These disk cartridges severally perform the recording and the reproducing of a disk by loading the disk into the disk drive apparatus, and by drawing in the disk holding body to the read/write position. Accordingly, downsizing of such a disk drive apparatus cannot be achieved unlike the disk drive apparatus of a bare disk.

Patent Document 4 discloses a disk cartridge which houses an optical disk in the cartridge main body. Once the disk cartridge is loaded in a disk drive apparatus, only the cartridge main body can be drawn out to the outside of the disk drive apparatus while leaving the optical disk inside the disk drive apparatus. Accordingly, also the disk cartridge of Patent Document 4 is loaded into the disk drive apparatus, and downsizing of the disk drive apparatus cannot be performed.

A disk cartridge of Patent Document 5 holds an optical disk in an exposed state. Accordingly, dust or the like may adhere to the optical disk, and there is the possibility of formation of scratches. Then, it is difficult to adopt the disk cartridge to a disk with a higher storage density. Moreover, also because the disk cartridge is loaded in a disk drive apparatus, it is also difficult to downsize the disk drive apparatus.
[Patent Document 1] Japanese Patent Publication No. 3373030
[Patent Document 2] Japanese Patent Application Publication No. 2000-260151
[Patent Document 3] Japanese Patent Application Publication No. 06-168566
[Patent Document 4] Japanese Patent Application Publication No. H06-131840
[Patent Document 5] Japanese Patent Application Publication No. 07-320359.

### SUMMARY OF THE INVENTION

The present invention is made in view of the above-mentioned situation. It is desirable to provide a disk cartridge that allows downsizing of the overall body and downsizing of a disk drive apparatus, and further to prevent a disk-like recording medium from being stained by loading only a disk-like recording medium into the disk drive apparatus.

Further, it is desirable to provide a disk cartridge that makes it possible to handle a disk-like recording medium with a higher storage density as a bare disk.

A disk cartridge according to an embodiment of the present invention includes: a cartridge main body, in which a disk insertion/ejection port for housing a disk-like recording medium and for inserting and ejecting the disk-like recording medium, formed on one of side surfaces that becomes an insertion end for an disk drive apparatus; and a disk holding body for holding the disk-like recording medium to be housed in the cartridge main body, the disk holding body being movable in an insertion direction into the disk drive apparatus. Further, if the disk holding body moves toward a side of the disk insertion/ejection port in the cartridge main body, the disk holding body makes at least a part of the disk-like recording medium expose to outside of the disk insertion/ejection port, thereby making the single disk-like storage medium transportable to the disk drive apparatus.

According to the present embodiment, if the disk holding body moves to the side of the disk insertion/ejection port in the cartridge main body, the disk holding body makes at least a part of the holding disk-like recording medium expose to outside of the disk insertion/ejection port, and makes the single disk-like recording medium transportable to the disk drive apparatus. Accordingly, the disk-like recording medium can be handled like a conventional bare disk. Hence, the disk-like recording medium with a higher storage density can be used as a recording medium, and downsizing of a disk drive apparatus may be achieved.

### BRIEF DESCRIPTION OF THE DRAWINGS

The above and other objects, features and advantages of the present invention will become more apparent from the following description of the presently exemplary embodiment of the invention taken in conjunction with the accompanying drawings, in which:

FIG. 1 is an exploded perspective view of a disk cartridge to which the present invention is applied;

FIG. 2 is a perspective view of the disk cartridge;

FIG. 3 is a perspective view showing a state in which an optical disk projects from a disk cartridge;

FIG. 4 is a perspective view showing a sate in which a disk cartridge is engaged with an opened portion of a disk drive apparatus;

FIG. 5 is a perspective view of a disk cartridge which is located at a position where the disk holding body houses the optical disk, and the upper half of which is removed;

FIG. 6 is a perspective view of a disk cartridge which is located at a position where a disk holding body exposes a part of the optical disk, and the upper half of which is removed; and

FIG. 7 is a perspective view for illustrating a state of transporting the optical disk.

### DETAILED DESCRIPTION OF THE EMBODIMENTS

Below, a disk cartridge according to an embodiment of the present invention is described with reference to the attached drawings.

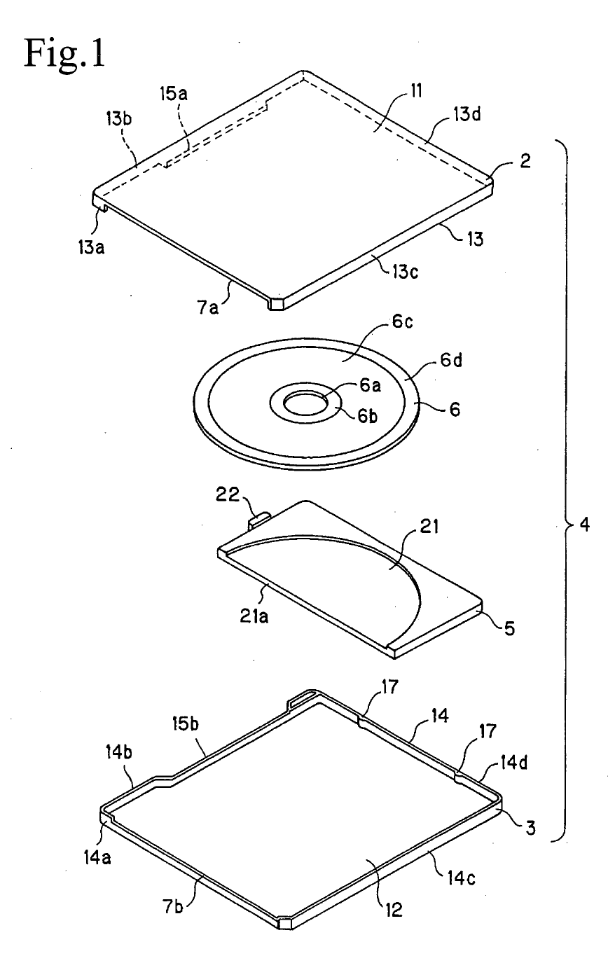

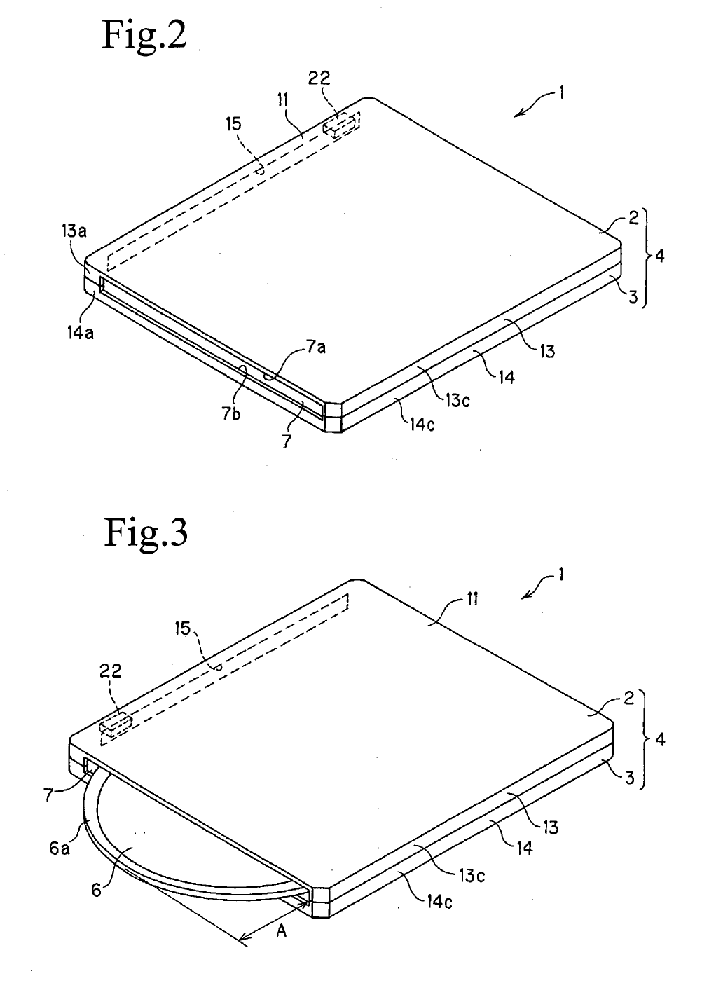

As shown in FIGS. 1-3, a disk cartridge 1, to which the present invention is applied, is provided with a cartridge main body 4 formed by facing and coupling a pair of upper and lower halves 2 and 3, and a disk holding body 5 which holds an optical disk 6 that serves as a recording medium and is movably housed in the cartridge main body 4.

In the optical disk 6 used in the disk cartridge 1, a center hole 6a is formed at the center the optical disk 6, and an internal circumference side non-signal recording region 6b is formed around the center hole 6a. Moreover, a signal recording region 6c is formed on an outer circumference side of the internal circumference side non-signal recording region 6b, and an external circumference non-signal recording region 6d is formed on the outer circumference side of the signal recording region 6c. The optical disk 6 is a recording medium made by providing a recording layer formed with a phase shifting material or an organic coloring substance on an optically transparent synthetic resin substrate such as polycarbonate, and by forming a reflection coating and a protective layer on the recording layer, for using the disk substrate side of the optical disk 6 as a signal reading surface. Alternatively, the optical disk 6 may be a recording medium made by providing a reflection film and a recording layer on a disk substrate, and by providing an optically transparent cover layer on the recording layer, for using the cover layer side as a signal reading surface. On such an optical disk 6 are recorded various information signals such as a picture video signal having a high image quality, a sound signal having a high fidelity, data to be processed by a computer and a computer program at a density higher than those of the existing optical disks such as a compact disc and a digital versatile disk. The recording medium to be used may be a magnetic disk, a magneto-optical disk and the like in addition to the optical disk 6.

The upper and lower halves 2 and 3 constituting the cartridge main body 4 for protecting the optical disk 6 described above is made by injection molding using a synthetic resin having mechanical strength and an overall shape of a rectangle or substantially rectangular shape. The substantially rectangular upper and the lower halves 2 and 3 each have a short side in a direction perpendicular to the insertion direction into the disk drive apparatus and a long side in the insertion direction into the disk drive apparatus. The setting of the direction of the long side to be the insertion direction into the disk drive apparatus makes it easy for a user to recognize the insertion direction into the disk drive apparatus. The size of the cartridge main body 4 may be equal to or more a size that allows the optical disk 6 to be in contact with or almost in contact with the inner side of the cartridge main body 4.

The upper and lower halves 2 and 3 have peripheral walls 13 and 14 around substantially rectangular principal plane portions 11 and 12, respectively. The inner part of the peripheral walls 13 and 14 are housing portions of the disk holding body 5 and the optical disk 6. At front walls 13a and 14a as the insertion ends of the peripheral walls 13 and 14 into the disk drive apparatus, recessed sections 7a and 7b constituting a disk insertion/ejection port 7 are formed. When the peripheral walls 13 and 14 of the upper and lower halves 2 and 3 are placed opposite to each other, the recessed sections 7a and 7b constitute the substantially rectangular disk insertion/ejection port 7 at the front surface of the cartridge main body 4. For decreasing the entering of foreign substances such as dust into the cartridge main body 4 to the utmost, the long side of the disk insertion/ejection port 7 is formed to be almost the same as the diameter of the optical disk 6, and the short side of the disk insertion/ejection port 7 is formed to be almost the same as the thickness of the optical disk 6. An opening and closing cover may be provided to the disk insertion/ejection port 7 for preventing the entering of dust and the like into the cartridge main body 4.

Side walls 13b, 13c, 14b and 14c which are opposed to each other and are in parallel to the insertion direction into the disk drive apparatus and further constitute the peripheral walls 13 and 14 of the upper and lower halves 2 and 3 function as guide walls of the disk holding body 5 moving in the cartridge main body 4 in the insertion direction into the disk drive apparatus. Moreover, the front walls 13a and 14a function as a stopper wall if the disk holding body 5 moving in the cartridge main body 4 moves toward the side of the front surface, and back walls 13d and 14d function as a stopper wall if the disk holding body 5 moves toward the side of the back surface. Projecting portions 17, against which the disk holding body 5 strikes, are formed on the back wall 14d.

On the side walls 13b and 14b on one sides of the upper and lower halves 2 and 3, respectively, recessed sections 15a and 15b are formed along from the front surface side to the back surface side of the side walls 13a and 14a of the upper and lower halves 2 and 3, respectively. When the upper and lower halves 2 and 3 are placed opposite to each other, the recessed sections 15a and 15b of the upper and lower halves 2 and 3 constitute a guide groove 15 for making a movement operation portion of the disk holding body 5 expose to the outside.

The cartridge main body 4 configured as above is not loaded into the disk drive apparatus, and only the optical disk 6 held by the disk holding body 5 is loaded into the disk drive apparatus. Accordingly, an opened portion for recording and reproducing, a drive opened portion and the like, through which a disk table constituting a disk rotation driving portion for rotating the optical disk 6 enters, are not formed in the cartridge main body 4 unlike the cartridge main body housing the optical disk of an existing disk cartridge. The formed opened portion is only the disk insertion/ejection port 7 formed on the front surface. By minimizing the opened portion, the cartridge main body 4 makes foreign substances such as dust difficult to enter into the cartridge main body 4 to the utmost in a simple configuration.

The disk holding body 5 housed in the above-mentioned cartridge main body 4 is formed to have, as a whole, a rectangular shape or almost rectangular shape having a long side being almost the same as the width of the cartridge main body 4, and a short side being almost a half of the depth from the front surface to the back surface of the cartridge main body 4. In the disk holding body 5, a disk holding portion 21 having a region being almost a half of the principal plane portion of the optical disk 6 is formed on the principal plane portion of one side. The disk holding portion 21 is formed to be almost a semicircle concave portion having a depth of capable of holding the optical disk 6. When the optical disk 6 is held in the disk holding portion 21, a projecting portion from a chord portion 21a of the disk holding portion 21 of the optical disk 6 faces to the outside of the cartridge main body 4 from the disk insertion/ejection port 7 of the cartridge main body 4.

A movement operation portion 22 facing to the outside from the guide groove 15 of the cartridge main body 4 is formed on a side wall on one side parallel to the moving direction of the disk holding body 5 in the cartridge main body 4. The movement operation portion 22 facing to the outside from the guide groove 15 is operated, for example, by a user for moving the disk holding body 5 from the back surface side to the front surface side or from the front surface side to the back surface side in the cartridge main body 4.

The disk holding body 5 may not be guided by the side walls 13b, 13c, 14b and 14c of the cartridge main body 4, but the movement may be guided by guide walls formed in parallel to the side walls 13b, 13c, 14b and 14c at further inner part to the side walls 13b, 13c, 14b and 14c.

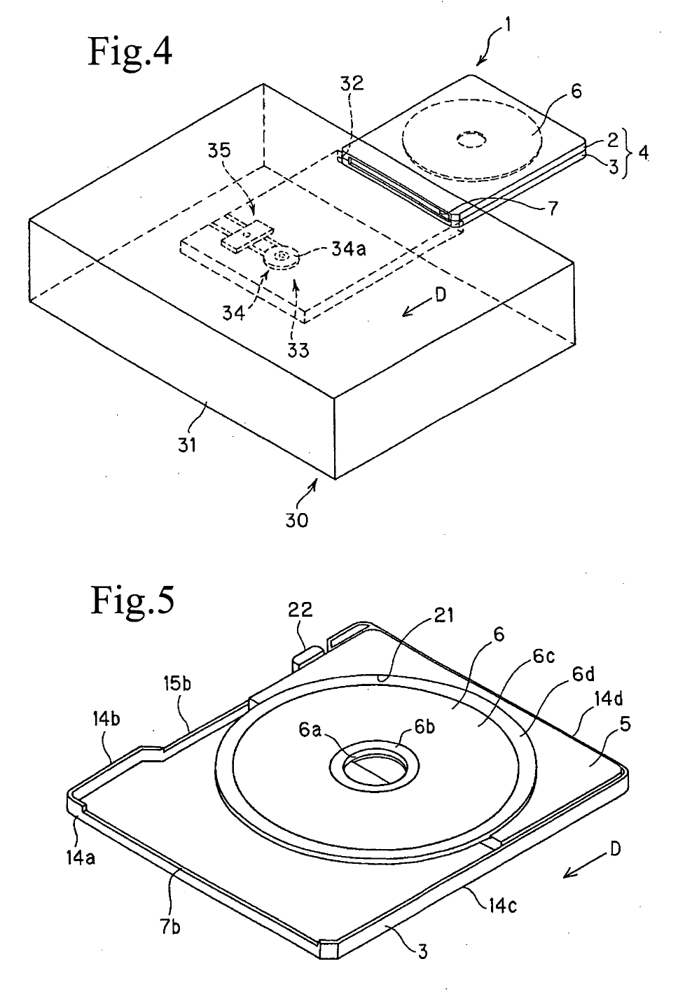

Now, a disk drive apparatus 30 of the disk cartridge 1, as shown in FIG. 4, includes an opened portion 32 formed on the front surface of the apparatus main body 31 to be engaged with the front surface of the cartridge main body 4. The opened portion 32 is formed to have almost the same size as that of the front surface of the cartridge main body 4. The opened portion 32 is formed to prevent the whole body of the cartridge main body 4 from entering therein, but to allow a small part of the cartridge main body 4 on the front surface side to be inserted. The opened portion 32 is configured so as that the optical disk 6 held by the disk holding body 5 in the cartridge main body 4 can be inserted into the disk drive apparatus 30 with the front surface of the cartridge main body 4 being engaged with the opened portion 32, and is configured so as that the optical disk 6 loaded in the disk drive apparatus 30 can be held by the disk holding body 5 in the cartridge main body 4. That is to say, the transportation of the optical disk 6 between the disk cartridge 1 and the disk drive apparatus 30 is performed while the cartridge main body 4 is engaged with the opened portion 32 and the inside of the cartridge main body 4 and the inside of the apparatus main body 31 form single continuous enclosed space.

Moreover, a recording and reproducing portion 33 for performing the recording and the reproducing of the optical disk 6 is formed in the apparatus main body 31. The recording and reproducing portion 33 includes a rotation drive unit 34 for rotating the optical disk 6, and an optical pickup 35 for radiating a light beam to the optical disk 6 and for detecting the reflected returning light beam. The rotation drive unit 34 includes a disk table 34a for engaging with the center hole 6a of the optical disk 6, and the like. The disk table 34a integrally rotate the optical disk 6 if the disk table 34a engages with the center hole 6a of the optical disk 6. Moreover, the optical pickup 35 radiates a light beam over a range from the internal circumference to the external circumference of the signal recording region 6c of the optical disk 6, and detects a returning light beam. Thereby, the optical pickup 35 performs the recording of an information signal to the optical disk 6, or the reproducing of an information signal recorded in the optical disk 6.

A transport mechanism for transporting the optical disk 6, though it is not shown in the drawing, is provided between the opened portion 32 formed on the front surface of the apparatus main body 31 and the recording and reproducing portion 33. The transport mechanism includes a pair of rotation rollers abutting on the external circumference surface of the optical disk 6, and transports the optical disk 6 between the opened portion 32 and the recording and reproducing portion 33. The transport mechanism may be otherwise configured to transport the optical disk 6 between the opened portion 32 and the recording and reproducing portion 33 while nipping the outer circumference non-signal recording region 6d of the optical disk 6.

Next, the operation of the optical disk 6 housed in the disk cartridge 1 until the optical disk 6 is transported to the recording and reproducing portion 33 of the disk drive apparatus 30 is described.

The disk cartridge 1 is, as shown in FIG. 5, located at a first position where the disk holding body 5 has been moved to the back surface side of the cartridge main body 4, i.e. to the opposite direction to an arrow direction D in FIG. 5, and fully housed the optical disk 6 in the cartridge main body 4, thereby preventing the optical disk 6 from being stained when the optical disk 6 is not used and housed in the disk cartridge 1. Moreover, the movement operation portion 22 of the disk holding body 6 housed in the cartridge main body 4 is located on the back surface side of the guide groove 15. Accordingly, a user can view that the optical disk 6 is housed in the inside.

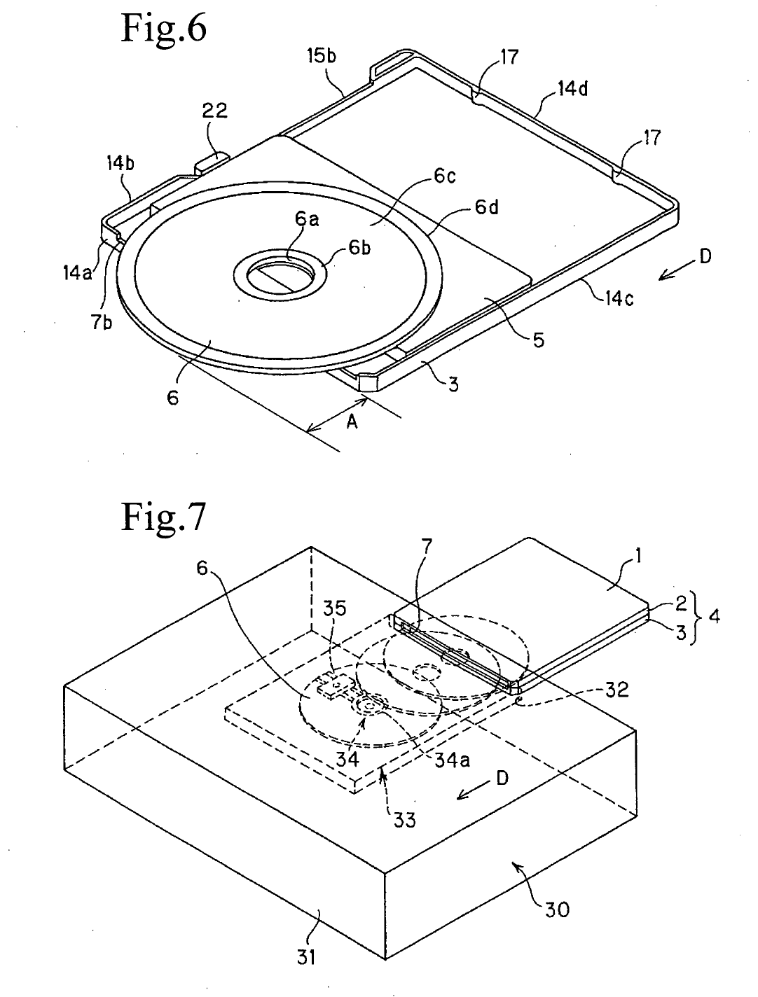

Next, the disk cartridge 1 is, as shown in FIG. 4, engaged with the opened portion 32 of the disk drive apparatus 30 with the front surface of the cartridge main body 4 being the insertion end. That is to say, the disk insertion/ejection port 7 of the cartridge main body 4 is connected to the opened portion 32 of the disk drive apparatus 30. Then, if the movement operation portion 22 of the disk holding body 5, which is located on the back surface side of the cartridge main body 4 in the guide groove 15, is slid into the arrow direction D in FIG. 5 that is the insertion direction of the optical disk 6, the disk holding body 5 moves to a second position shown in FIG. 6 while being guided by the side walls 13b, 13c, 14b and 14c. When the disk holding body 5 has moved in the cartridge main body 4 from the first position on the back surface side to the second position on the front surface side, a part of the optical disk 6 held by the disk holding body 5, for example about a half region thereof, is exposed from the disk insertion/ejection port 7 to the outside of the cartridge main body 4, and enters the inside of the opened portion 32 of the apparatus main body 31. A projected amount A of the disk insertion/ejection port 7 of the optical disk 6 is set to be equal to or more of a quantity that is sufficient for enabling the transport mechanism on the side of the disk drive apparatus 30 to transport the optical disk 6. Then, the optical disk 6 facing to the outside of the cartridge main body 4 is, as shown in FIG. 7, transported by the transport mechanism on the side of the disk drive apparatus 30 to the recording and reproducing portion 33 in the apparatus main body 31. When the optical disk 6 is transported from the inside of the cartridge main body 4 to the recording and reproducing portion 33 of the disk drive apparatus 30, the front surface of the cartridge main body 4, at which the disk insertion/ejection port 7 is formed, is engaged with the opened portion 32 of the apparatus main body 31, and the inside of the cartridge main body 4 and the inside of the apparatus main body 31 form a continuous enclosed space portion. Accordingly, it can be prevented for the optical disk 6 from being stained.

The optical disk 6 is mounted on the disk table 34a of the recording and reproducing portion 33, and is rotated together with the disk table. Then, a light beam emitted from the optical pickup 35 is radiated over a range from the internal circumference to the external circumference of the signal recording region 6c of the optical disk 6, and a reflected returning light beam is detected by the optical pickup. Accordingly, the writing of an information signal to the optical disk 6 and the reading of an information signal recorded in the optical disk 6 are performed. As described above, when the recording or the reproducing of the optical disk 6 is performed, the optical disk 6 is transported by the recording and reproducing portion 33 as a single body, and is handled as a bare disk like the conventional compact disc and the digital versatile disk.

If the optical disk 6 is loaded by the disk drive apparatus 30, the cartridge main body 4 having no optical disk 6 therein may be in an engaged state with the opened portion 32, or may be removed from the opened portion 32. When the cartridge main body 4 is removed from the opened portion 32, the disk holding body 5 of the disk cartridge 1 is configured to continue to be held on the front surface side of the cartridge main body 4. Thereby, the movement operation portion 22 continues to be located on the front surface side of the guide groove 15, and consequently the user can judge whether or not the optical disk 6 exists in the cartridge main body 4 by viewing the position of the movement operation portion 22.

If the optical disk 6 to which recording or reproducing has been completed is taken out from the disk drive apparatus 30, as shown in FIG. 7, the front surface of the cartridge main body 4 is first engaged with the opened portion 32 of the apparatus main body 31, and the opened portion 32 and the disk insertion/ejection port 7 are made to construct a continuing space. Then, the optical disk 6, located at the recording and reproducing portion 33, is transported from the recording and reproducing portion 33 to the opened portion 32 by the transport mechanism, and the optical disk 6 transported to the opened portion 32 enters the inside of the cartridge main body 4 through the disk insertion/ejection port 7 of the cartridge main body 4. Moreover, the optical disk 6 is held by the disk holding body 5 located on the front surface side of the cartridge main body 4. Then, the movement operation portion 22 facing to the outside of the guide groove 15 of the cartridge main body 4 is moved by the user from the front surface side to the back surface side of the cartridge main body 4, and thereby also the disk holding body 5 holding the optical disk 6 moves toward the anti-arrow direction D in FIG. 7. Accordingly, the optical disk 6 held by the disk holding body 5 takes a fully housed state in the cartridge main body 4, and after that, the cartridge main body 4 is removed from the opened portion 32 of the apparatus main body 31.

Because, in the disk cartridge 1 configured as above, only the optical disk 6 is inserted into the disk drive apparatus 30 and the cartridge main body 4 and the disk holding body 5 are not inserted, the disk drive apparatus 30 can be downsized. Moreover, because the delivery of the optical disk 6 between the disk cartridge 1 and the disk drive apparatus 30 is performed after the front surface side of the cartridge main body 4 has been engaged with the opened portion 32 of the disk drive apparatus 30 to connect the opened portion 32 and the disk insertion/ejection port 7 and the inside of the cartridge main body 4 and the inside of the apparatus main body 31 have formed a continuous enclosed space, it can be prevented for the optical disk 6 from being stained.

It should be understood by those skilled in the art that various modifications, combinations, sub-combinations and alterations may occur depending on design requirements and other factors insofar as they are within the scope of the appended claims or the equivalents thereof.

1. A disk cartridge comprising:
a cartridge main body, in which a disk insertion/ejection port for housing a disk-like recording medium and for inserting and ejecting the disk-like recording medium, formed on one of side surfaces that becomes an insertion end for an disk drive apparatus; and
a disk holding body for holding the disk-like recording medium to be housed in the cartridge main body, the disk holding body being movable in an insertion direction into the disk drive apparatus;
wherein, if the disk holding body moves toward a side of the disk insertion/ejection port in the cartridge main body, the disk holding body makes at least a part of the disk-like recording medium expose to outside of the disk insertion/ejection port.
